(19) United States
(12) Patent Application Publication
(10) Pub. No.: US 2011/0029994 A1
(43) Pub. Date: Feb. 3, 2011

(54) OPTICAL DISK DRIVE DEVICE

(76) Inventor: Shunghun Woo, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/845,399

(22) Filed: Jul. 28, 2010

(30) Foreign Application Priority Data
Jul. 28, 2009 (KR) 10-2009-0068690

(51) Int. Cl. G11B 17/028

(52) U.S. Cl. 720/706; G9B/17.006

(57) ABSTRACT

Disclosed herein is an optical disk drive device comprising an spindle motor rotating a turntable on which an optical disk is safely placed; a clamper adhering the optical disk to the turntable to clamp the optical disk into the turntable; and an upper case provided with a hollow part so opened as to make the clamper face the turntable, and a support part contacting and supporting the clamper as an edge of the hollow part, the support part being inclined against the turntable.

### CROSS-REFERENCE TO RELATED APPLICATION

This application claims the benefit under 35 U.S.C. §119 of Korean Patent Application No. 10-2009-0068690, filed on Jul. 28, 2009, which is hereby incorporated by reference in its entirety.

### FIELD OF THE DISCLOSURE

The present invention relates to an optical disk drive device.

### DESCRIPTION OF THE RELATED ART

Generally, an ‘optical disk drive device’ refers to a device configured to write or reproduce data in an optical disk adapted to read or write any data by the illumination of light, for example CDs, DVDs, blue-ray DISCs, etc.

The optical disk drive device includes an optical pickup for illuminating light onto an optical disk and processing an optical signal reflected from the optical disk, a main PCB processing the signal inputted/outputted from the optical pickup, a spindle motor for safely placing and rotating the optical disk, and a sled motor feeding the optical pickup in a radial direction of the optical disk.

The optical pickup can accurately access a track that records optical disk data through a focus servo action to move an object lens in the upward/downward direction and a tracking servo action to move the object lens in the radial direction.

On the one hand, energy force for the clamping or unclamping an optical disk to the optical disk drive device is produced by the magnetic force acting between a clamper and a turntable, and in a case the clamper approaches the turntable, the optical disk is clamped onto the turntable by the magnetic force, and the state of the optical disk is released by compulsively detaching the turntable from the clamper.

However, in a case the magnetic clamping force is overpowered, it takes considerable energy to detach the clamper from a spindle motor during unclamping, resultantly disturbing the normal operation of the optical disk drive device. On the other hand, in a case the magnetic force acting between the clamper and the spindle motor is reduced to perform a smooth unclamping, the clamping force decreases to make it difficult to keep a concentric status to the optical disk and the spindle motor.

### BRIEF SUMMARY

The present invention provides an optical disk drive device configured to dispense with an excessive burden onto a deck during unclamping, and to smoothly detach the clamper from a spindle motor through improvement of an unclamping structure.

In one embodiment, an optical disk drive device of the present invention includes a spindle motor rotating a turntable on which the optical disk is safely placed; a clamper clamping the turntable into the optical disk; and an upper case provided with a hollow part so opened as to allow the clamper to face the turntable and a support part supportively contacting the clamper as an edge of the hollow part, wherein the support part is inclined against the turntable.

In another embodiment, an optical disk drive device of the present invention includes a deck installed with a spindle motor rotating a turntable on which an optical disk is safely placed; and an upper case adapted to support a clamper, the clamper clamping the optical disk to the turntable by adhering it to the turntable with magnetic force, wherein a first side corresponding to a lowermost end of the clamp first faces the turntable in a case the deck starts to ascend, the clamp is detached from the upper case in a case the deck stops ascending, and the clamper is detached from the turntable in a case the deck ascends by a second side opposite to the first side contacting and interfering with the upper case.

### BRIEF DESCRIPTION OF THE DRAWINGS

FIG. 1 is an exploded perspective view showing an optical disk drive device according to the present invention;

FIGS. 2 and 3 are lateral cross-sectional views according to imaginary embodiments to compare with an embodiment of the present invention; and

FIGS. 4 and 5 are lateral cross-sectional views showing the loading and unloading actions of an optical disk drive device according to an embodiment of the present invention.

### DETAILED DESCRIPTION

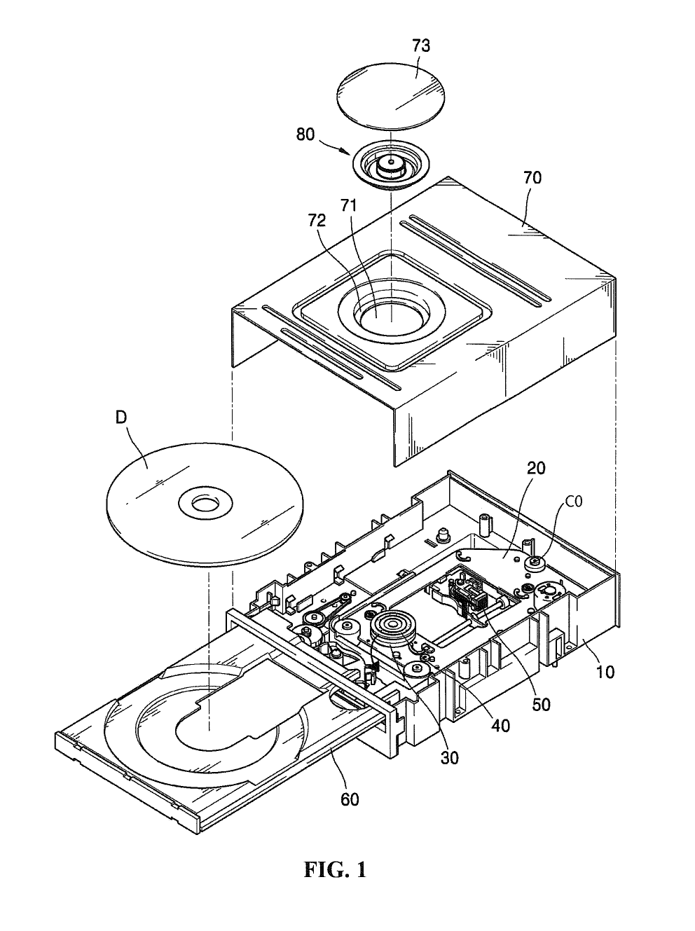

FIG. 1 is an exploded perspective view illustrating an optical disk drive device of the invention.

Referring to FIG. 1, the optical disk drive device includes a main frame 10, an upper part case 70 coupled to an upper part of the main frame 10, and a tray 60 for transporting a disk D into the optical disk drive device.

The disk D transported by the tray 60 is safely placed on a turntable 40 installed at the upper part of a spindle motor 30. The turntable 40 is coupled to the rotation shaft of the spindle motor 30 and rotates the disk D while rotating together with the rotation shaft. The spindle motor 30 is installed at the deck 20 coupled to the main frame 10, and an optical pickup 50 is installed at the deck 20.

The optical disk drive device is provided with a clamping device clamping the disk D to the turntable 40 to inhibit the disk D from slipping on the rotation of the turntable 40.

As a clamping device, the clamper 80 fixing the disk D to the upper surface of the turntable 40 is liftably installed at the upper case 70.

A hollow part 71 is penetratingly formed at the center part of the upper case 70, and a support part 72 protruding from the lower side of the upper case 70 is provided along the edge of the hollow part 71. The clamper 80 is inserted into the hollow part 71 in a state supported by the support part 72, and the upper part of the hollow part 71 is covered with a cover plate 73.

A magnet 42 is installed at the inner side part of the turntable 40, and a metal plate correspondingly is installed at the clamper 80. Alternatively, a metal plate may be installed at the inner part of the turntable 40 and a magnet may be installed at the clamper 80. The disk D is clamped by magnetic force acting between the magnet 42 and the metal plate 82.

The disk D is placed upon the tray 60, and in a disk seated state the tray 60 is loaded into the inside of the optical disk drive device. When the loading is completed by fully inserting the tray 60, the deck 20 elevates, and in a case the spindle motor 30 approaches the clamper 80 along the deck 20 ascent, the disk D clamping is completed by pressing down an upper side of the disk D by the clamper 80 with magnetic force between the clamper 80 and the turntable 80. Successively, the spindle motor 30 rotates and the optical pickup 50 inputs/outputs an optical signal into/from a data record surface of the disk D.

The turntable 40 is coupled to the spindle motor 30 and the spindle motor 30 is fixed to the deck 20 so that the ascent and descent of the turntable 40 is performed according to the ascent and descent of the deck 20. The ascent and descent of the deck 20 may be done according to an embodiment (not shown) in which the deck itself rises and falls vertically. And the spindle motor 30 ascends or descends on the other side of the deck 20 rotating in forward/backward directions about a rotation centre CO where any one clamper is fastened according to an embodiment illustrated in FIG. 1.

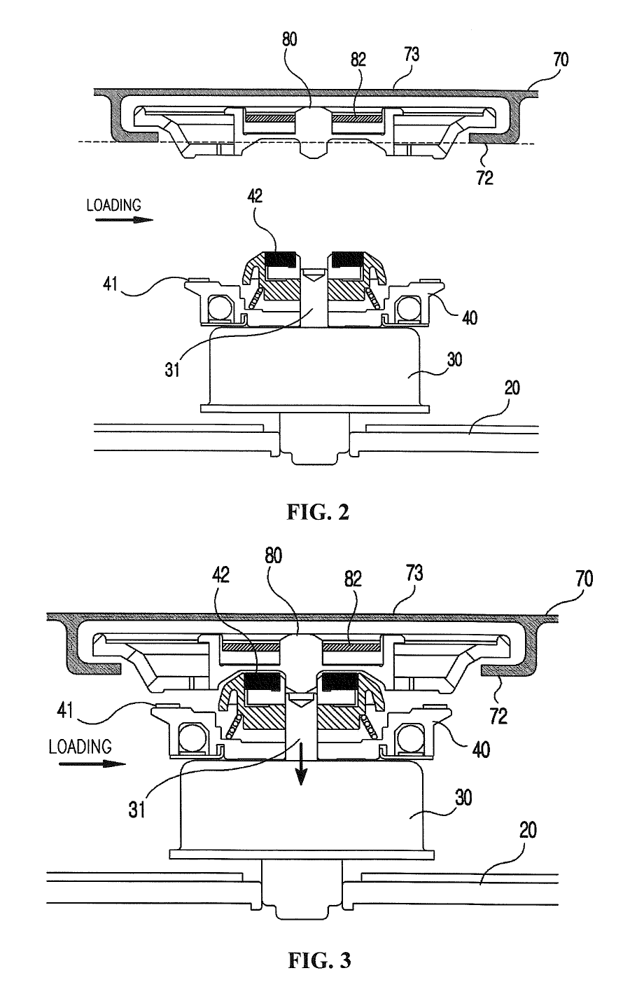

FIGS. 2 and 3 are lateral cross-sectional views according to imaginary embodiments to compare with an embodiment of the present invention.

First, referring to FIG. 2, before the turntable 40 is raised, the clamper 80 stays connected with a support part 72 by its own weight. In a case the turntable 40 is raised to approach the clamper 80, the turntable 40 is initially contacted with the clamper 80.

Although not shown, when the turntable 40 continuously rises in a state the clamper 80 contacts the support part 72, the clamper 80 is detached from the support part 72, where such a position of the clamper 80 is defined as ‘clamping position’. At this time, even if the spindle motor 30 rotates, the clamper 80 may freely rotate in a state the clamper 80 does not contact and interfere with the support part 72.

Next, referring to FIG. 3, the turntable 40 starts descending for clamping. The clamper 80 descends down to contact the support part 72 after being detached from the support part 72. In a case the turntable continuously descends while the clamper 80 contacts the support part 72, the clamper 80 is separated from the turntable 40. For the sake of convenience, the position of the clamper 80 as shown in FIG. 3 is defined as ‘unclamping position’.

However, in a case there is no step difference in the height of the support part 72 as shown in FIGS. 2 and 3, the clamper 80 contacts the support part 72 in its entire outer appearance and the clamper 80 and the turntable 40 are detached from each other over all the contact area right prior to being in the unclamping position, whereby considerable load is needed for descending the turntable 40 during unclamping.

At this time, magnetic force acting between the clamper 80 and the turntable reaches a peak load that concentratively acts for a short time (this is called a ‘clamping force’ or an ‘unclamping force’). To smoothly perform the unclamping of the clamper 80 and the turntable 40, a descending force for separation of the turntable 40 should be large enough to suppress the peak load.

As such, although a force holding the optical disk becomes stronger in proportion to the clamping force, there occurs a fault incapable of separating the clamper 80 and the turntable 40 due to the action of magnetic force, or considerable force is consumed in unloading the tray 60 to the outside of the optical disk drive device, in a case the tray 60 is transferred in a backward course of the loading direction in a ‘no disc’ state in which the optical disk is not safely placed.

Also, in a case the tray 60 is inserted into the optical disk drive device in the loading direction, the clamper 80 and the turntable 40 instantly stick each other, which can cause noise.

On the other hand, it is not allowed to greatly set the upper limit value of the clamping force, so that there are some constraints in increasing the clamping force for improvement of centering performance.

Furthermore, it is difficult to managing an intensity range of the magnet 42 installed at the clamper 80 or the turntable 40.

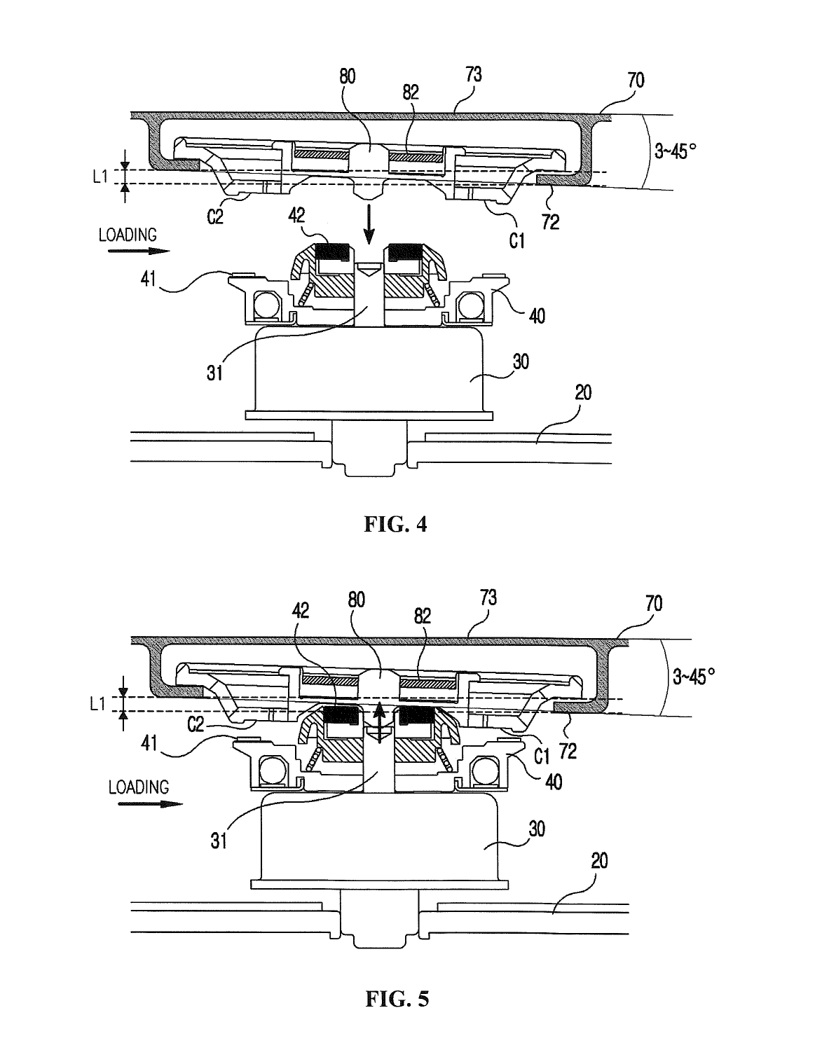

By comparison, FIGS. 4 and 5 are lateral cross-sectional views diagrams showing the loading and unloading actions of an optical disk drive device according to the present invention.

In the present invention shown in FIGS. 4 and 5, in a case the support part 72 has a step differences L1 and the tray 60 is unloaded into the exterior of the optical disk drive device under no disk state, the clamper 80 and a second side C2, which is one side of the turntable 40 are initially separated to decrease the unclamping force, whereby separation by small force is possible.

As a result, it is preferable that the support part 72 be 3˜45° inclined against the upper part case 70.

On the other hand, in a case the tray 60 is loaded to the inside of the optical disk drive device under no disc state, a first side, which is the other side of the clamper 80 and the turntable 40 are initially contacted, thereby suppressing the clamping noise.

Therefore, even if the magnet 42 intensity installed in the clamper 80 or the turntable 40 is made stronger, there is no overstrain in the loading and unloading action of the optical disk drive device, and even though the intensity range of the magnet 42 has a certain degree of deviation, it is possible that excessive load may not act on the optical disk drive device.

According to the present invention mentioned above, the upper case 70 is provided with the hollow part 71 and the support part 72, the hollow part 71 is open for the clamper 80 to face the turntable 40, and the support part 72 is a curved part to contact and support the clamper 80 as the edge of the hollow part 71, and the support part 72 is inclined against the turntable 40.

The hollow part 71 is cut in a curved form from a part of the upper case 70, and the support part 72 has an ‘L’ shaped cross section in which the edge of the hollow part 71 is curved toward the spindle motor 30.

That is, in order that detached distances between the support part 72 and the turntable 40 differ from each other, a step height L1 is formed at the support part 72. According to this, a detachment distance between the support part 72 and the turntable 40 on the upstream of the loading direction of an optical disk is more distanced than a detached distance between the support part 72 and the turntable 40 on the downstream of the optical disk loading direction by step height L1.

In a loading or clamping of the optical disk, the deck 20 is rotated, and the support part 72 has a shape in which the second side C2, i.e. the farther side from the rotation center CO of the deck 20, is more distanced from the turntable 40 than the first side C1, that is the nearer side from that of the deck 20.

Referring to FIGS. 1, 4 and 5, the first side C1 corresponding to the lowermost of the clamper 80 first faces the turntable 40 when the deck 20 starts to ascend, and the clamper 80 is detached from the upper part case 70 in a case the deck 20 completes the ascending, and during descent of deck 20 the second side C2 of the clamper 80, opposite to the first side C1, first contacts and interferes with the support part 72 of the upper part case 70 so that the clamper 80 is detached from the turntable 40.

While embodiments according to the present invention have been described above, these are only by way of example and it would be understood by those skilled in the art that any embodiment of various modifications and equivalents can be made thereto. Thus, the genuine technical scope of the present invention should be defined from the accompanying claims.

What is claimed is:

1. An optical disk drive device comprising:
a spindle motor rotating a turntable on which an optical disk is safely placed;
a clamper adhering the optical disk to the turntable to clamp the optical disk into the turntable; and
an upper case provided with a hollow part so opened as to make the clamper face the turntable, and a support part contacting and supporting the clamper as an edge of the hollow part,
wherein the support part is inclined against the turntable.

2. The optical disk drive device of claim 1, wherein a step difference is formed at the support part to differ a detached distance between the support part and the turntable from each other.

3. The optical disk drive device of claim 2, wherein the step difference is formed at the support part so that a detachment distance between the support part and the turntable on the upstream side of a loading direction of the optical disk is farther than a detached distance between the support part and the turntable on the downstream side of a loading direction of the optical disk.

4. The optical disk drive device of claim 1, wherein the device comprises a deck, the deck adapted to fix the spindle motor and rotating in the loading or clamping of the optical disk,
wherein the support part has a shape in which a farther side from the rotation center of the deck is more distanced from the turntable.

5. The optical disk drive device of claim 1, wherein the hollow part is cut from a part of the upper part case in circular form,
wherein the support part has a bracket shape cross section in which the edge of the hollow part is curved toward the spindle motor.

6. The optical disk drive device of claim 1, wherein the support part is 3˜45° inclined against the upper part case.

7. The optical disk drive device of claim 1, wherein a turntable adjacent portion of said clamper first contacts the turntable by the ascent of the turntable, wherein the said clamper is disposed in the support part arranged inclinedly against the turntable.

8. An optical disk drive device comprising:
a deck installed with a spindle motor rotating a turntable on which an optical disk is safely placed; and
an upper case adapted to support a clamper, the clamper clamping the optical disk into the turntable by adhering it to the turntable by magnetic force,
wherein a first side corresponding to the lowermost stage of the clamper first faces the turntable when the deck starts ascending,
the clamper is detached from the upper part case when the deck stops ascending, and
the clamper is detached from the turntable by first contacting and interfering a second side, opposite to the first side, with the upper case, upon the descent of the deck.
